(19) United States
(12) Patent Application Publication
(10) Pub. No.: US 2005/0274314 A1
(43) Pub. Date: Dec. 15, 2005

(54) Apparatus to repel and deter non-raptorial birds and animals including but not limited to squirrels, rabbits, mice, rats, and deer from selected areas of a property

(76) Inventors: William David Norton, Hollywood, MD (US); Alan Glenn Smith, Mechanicsville, MD (US)

Correspondence Address: WILLIAM DAVID NORTON, 24835 HALF PONE POINT ROAD, HOLLYWOOD, MD, 20636, US

(21) Appl. No.: 10/868,735

(22) Filed: Jun. 15, 2004

(51) Int. Cl. A01M 29/00

(52) U.S. Cl. 116/22 A

(57) ABSTRACT

An apparatus to repel non-raptorial birds and animals including but not limited to squirrels, rabbits, mice, rats, and deer from selected areas of a property. The apparatus, when placed in an area, convinces the birds and animals of the presence of a predator, a human being, and/or some other perceived threatening presence or a danger that self-motivates the birds and animals to avoid the area and prevents thus the contamination, defacing, and/or damage to the area from the bird feces or nesting and consumption and/or damage of garden plants, agricultural crops, trees, and/or shrubs by the other animals.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of repelling birds and animals from an area of property and more specifically to an apparatus to repel non-raptorial birds and animals including but not limited to squirrels, rabbits, mice, rats, and deer from selected areas of a property.

The past technology base for this invention revolves around the use of devices and chemicals to deter wild birds and animals from encroaching and invading an area of a property where the birds or animals created a nuisance, defaced, consumed and/or destroyed parts of the property, or left behind feces and other contaminants that fouled piers or swimming pool decks and water. The technology base includes any method, device, or chemical that does not exterminate the bird or animal or remove the bird or animal to another location but acts as a deterrent that self motivates the bird or animal to keep out of the designated area and the bird or animal moving on to other areas within the same territory.

Examples of past and present technology and patents are: 1. A physical barrier or fence, including barbed wire, fixed, and electric, 2. Chemicals or Food material deterrents. For example the odor of eggs will deter a deer from eating new growth on pine trees. 3. The use of facsimiles of human beings—For example Scare Crows, 4. The use of facsimiles of predators like owls and hawks, 5. The use of sonic and ultrasonic sound devices triggered by some animal presence detector. 6. The use of light to expose night animals, 7. The use of water spraying devices triggered by some animal presence detector, 8. The use of reflectors or other representations of a visual threat or danger on a motorized arm, and 9. The use of devices including but not limited to aluminum pie pans and mirrors that reflect light and/or create noise to deter or repel birds and animals.

All of the past technology devices and methods can be expensive, can and do require maintenance or replenishment of materials and chemicals, and can be noisy. The effectiveness of all the past technology devices and methods was low relative to cost of ownership and especially if the device or method was not replenished with consumable materials and chemicals as required, powered properly, or maintained properly. Also, the animals would get acclimated to the presence of devices like scare crows, plastic owls, and aluminum pie plates because they were not animated enough or variable enough due to their lack of degrees of freedom of motion and other dimensions, configurations, and enhancements that were discovered through the development of this invention.

This invention utilizes the reflection and refraction of light in a new, unique, and innovative way as the method of deterrence. It was designed, developed, tested, and perfected over a period of two years (2002 to present). It began when a problem with birds contaminating a swimming pool deck and water with feces droppings. The birds would actually transport the waste feces of their young from their bird's nest and drop them from the air onto the deck and into the water of the swimming pool. The adult birds also did the same with their own feces, but they would land on the pool decking and deposit feces there and deface the deck or even drop their own feces from the air onto the deck or into the pool water. It was discovered through some experimentation that computer CD ROM disks reflect light in such a way (both reflection and refraction) that it could be effective in deterring birds and animals. The normal approach through prior technology attempted to utilize the same method of this invention utilizing motors to turn an arm with reflective material only, utilize a spray of water to startle an animal once detected, use predator sounds or ultrasound to confound animals of the presence of a predator, chemical agents or organic chemical odors that were offensive to some animals, and/or to simply string up one or more aluminum pie plates that would both reflect light and make noise. The same idea was implemented with CD ROM disks but they were not very effective because the approach and basis for their use was more or less a random approach to get some recycled use from CD ROMS but the approach was not developed properly. This was also not aesthetically pleasing and not very effective. After much more experimentation with configuration, a design was conceived and perfected that is very effective and overcomes all of the shortfalls of prior technology stated previously. This invention is very effective and in field-testing, the invention totally eliminated the swimming pool deck and water contamination problems. Field-testing has also proven the device is also very effective on squirrels, rabbits, mice, rats, and deer deterrence. Once installed, the invention is maintenance free and requires no electrical power or chemicals. All other prior technologies in the bird and animal deterrence field require maintenance, electric power, and/or replenishment of batteries, water, or chemicals.

### BRIEF SUMMARY OF THE INVENTION

The primary object of the invention is to provide an apparatus that will non-violently protect an area of property from contamination, defacing, consumption, and/or destruction by birds and animals by deterring and/or repelling said creatures from the area of property requiring protection.

Another object of the invention is to provide an apparatus that accomplishes the deterrence purpose that is environmentally neutral and does not harm birds and animals in any way.

Another object of the invention is to provide an apparatus that takes advantage of recycling of man made materials.

A further object of the invention is to define a standardized, fixed, and scientifically proven configuration developed from research on animal self preservation behavior with respect to perception of truth, observing the effects of different materials, dimensions, and configurations of the invention on animal behavior so that the most simple and effective apparatus was realized.

A still further object of the invention is to be totally maintenance free once installed.

Yet another object of the invention is to be aesthetically pleasing to Human Beings and to fit in any modern decor.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus to repel non-raptorial birds and animals including but not limited to squirrels, rabbits, mice, rats, and deer from selected areas of a property. The apparatus, when placed in an area, convinces the birds and other animals of the presence of a predator, human being, and/or some other perceived presence or danger that causes them to avoid the area and prevents thus the contamination, defacing, and damage to said area from their feces and nesting (birds), and consumption and damage of garden plants, agricultural crops, trees, and/or shrubs (other animals) comprising: 1. Two highly reflective and refractive 4¾″ disks with a center image the whole simulating a threat and/or representing the presence of a threat to non-raptorial birds and animals by representing two eyeballs, 2. A concentric white ring area 1¾″ diameter that surrounds the center of the disk presenting the iris part of an eye or the actual image of a human or predator animal iris and pupil, 3. A black center area ½″ diameter that presents the pupil of an eye or the actual image of a human or predator animal pupil, 4. Eight major degrees of freedom (DOF) of movement. Two of the eight DOF's are limited to a specific range of rotation to simulate eye movement, 5. Silent operation, 6. Requiring no external or man supplied source of energy to operate, 7. Requiring no chemicals or batteries, and 8. A specific geometric design, with critical dimensions, and specific materials that have been field proven to be the most effective in achieving the desired deterrent result. 9. A special low friction pole mount accessory for use in open areas where the device cannot be suspended. The pole mount allows the device complete freedom of rotation in the plane perpendicular to the pole, 10. A wall mount accessory that allows the device to be suspended from a surface more or less perpendicular to the ground plane, and 11. A torsion suspension cable that limits the rotation of each disk to within 60 degrees from either side of the resting position parallel to the length dimension of the support rod. 12. Very sensitive to external forces including but not limited to thermal air currents and wind which cause the apparatus to move.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic diagram illustrating the overall operation and function of the invention.

FIG. 2 is a schematic diagram illustrating the details of the design of the two double-sided refractive reflective disks.

FIG. 3 is a schematic diagram illustrating the details of the Low Friction Pivoting Support accessory.

FIG. 4 is a schematic diagram illustrating the details of the Vertical Surface Mount Support accessory.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

Turning now to the drawings wherein the showings are for purposes of illustrating preferred embodiments of the present invention only, and not for purposes of limiting the same. In accordance with the present invention, the classic approach and goal is to present the visual method only for every embodiment of the apparatus that more or less would visually be perceived by non-raptorial birds and animal including but not limited to squirrels, rabbits, mice, rats, and deer (hereinafter referred to as “birds and animals”) as dangerous or life threatening by its presence and its operation. The invention herein described utilizes the classic approach in a new, innovative, and exclusive embodiment that is not obvious to the person of ordinary skill in this area. This was discovered by searching the patent applications to date and realizing that no application for patent or award of patent was found in a search for bird and/or animal deterrents for a patent that embodies what is disclosed herein for the subject invention. This is deduced to be the result of the advancement of technology for producing refractive and reflective disks being recently developed and the extraordinary skills required for all areas of research, development, test, and evaluation of this invention.

Further referring to the drawings wherein the showings are for the purpose of disclosing what is new and innovative, the inventors present as new a never before invented apparatus for the deterrence of both birds and animals that is as effective or more effective in its operation than any other animal deterrent invention to date, requires no maintenance once installed, requires no electrical power to operate, requires no chemicals or water, produces no sound, and is perceived to be a live predator, human being, and/or some other threat to birds and animals.

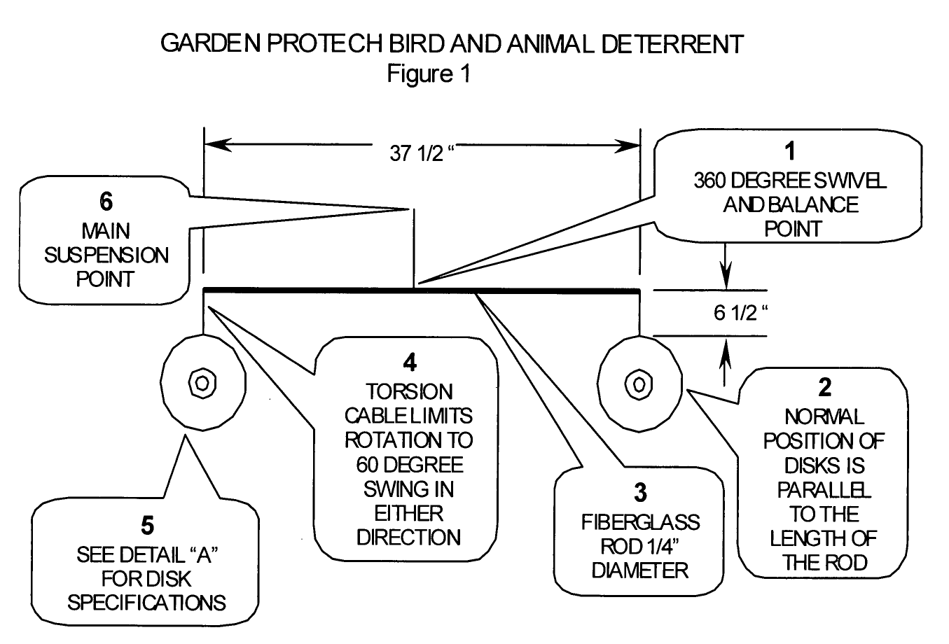

Turning first to FIG. 1 there is shown an overall schematic view of the main apparatus. In accordance with the present invention, there is shown in FIG. 1 how the apparatus is presented to birds and animals as a pair of eyes on a head as if a predator, human being, or some other perceived threat as present. In the preferred embodiment the apparatus operates by moving about eight degrees of freedom and the prime mover is air current micro pressures either thermal or pressure gradient. The operation of the apparatus convinces the birds and animals to be a living presence and danger and therefore repels and/or deters birds and animals from a selected area of property or causes the birds and animals to avoid the area. When the birds and animals are repelled from the area, the property is not contaminated, defaced, and/or damaged by the birds and animals. By way of illustration of some key aspects of animal behavior invoked by the present invention, animals are for the most part either entirely color blind or see a few color shades and the eyesight of animals is a near sightedness and therefore poor relatively speaking. Because an animal's eyes see in black and white, the animal is very keen in contrasting and detecting minute movements. A bird's eyesight is better and in flight birds see the apparatus as two eyes stalking them as prey as they enter the area by air. In the illustrated embodiment, the apparatus, although larger than life, is still perceived by the bird or animal as a normal size threat or danger beginning at a distance farther away because of the life like appearance and motion of the apparatus at a distance farther removed. Thus, in the present embodiment, a larger surface area of property is protected. The apparatus rotates on an axis (1) like the head of an owl or other raptor bird that is perched and surveying would move and the disks from the air appear as a set of eyes that move back and forth (4) quite like a bird of prey. The bird will not come into the area from a good distance while animals on land will see another predator animal watching them as they approach from a shorter distance than birds. The light flashes and rotation (4) of prism light swirls causes the animal to take notice of the apparatus and when the animal focuses on the device it sees the eyes, discerns danger, and departs the area. Birds avoid the area altogether. Birds have been observed dropping nest debris and their young's wastes from the air into a swimming pool. The birds would also bathe in the pool water, perch on the deck, defecate on the deck and from the air into the swimming pool water. In accordance with one aspect (one of the main features) that the invention embodies is the ability to appear alive even when the apparatus is not in motion. The disks not only reflect light like a mirror, but they also refract light so that the light pattern appears to move when the animal moves relative to the disks (2) and the apparatus. The animated action confounds the bird or animal into sensing the presence of a threat and the bird or animal avoids the area and is deterred or repelled from the area. The apparatus is very effective on non-raptorial birds and animals including but not limited to squirrels, rabbits, mice, rats, and deer. The apparatus has been tested in the field and the embodiment disclosed has been proven to be very effective. For example: 1. The swimming pool area, water, and deck are no longer contaminated and defaced when the apparatus is placed 6 feet above the ground and approximately 12 feet from the swimming pool wall. When the apparatus is removed the contamination and defacing begins the following day. 2. Squirrels are repelled and deterred from a shed where nuts are stored. Their behavior has been observed as approaching the shed, realizing the presence of the apparatus, standing on their hind legs frozen to observe, and then immediately departing when a motion is perceived on the apparatus. When the apparatus is removed, within 2-3 hours the squirrels are finding their way into the shed for the nuts. and 3. Deer footprints disappeared in an area after the apparatus was installed and returned soon after the apparatus was removed. It is important to note that the design of the apparatus was modified and optimized to increase the effectiveness by cause and effect experimentation and the disclosure represents the results of two years effort.

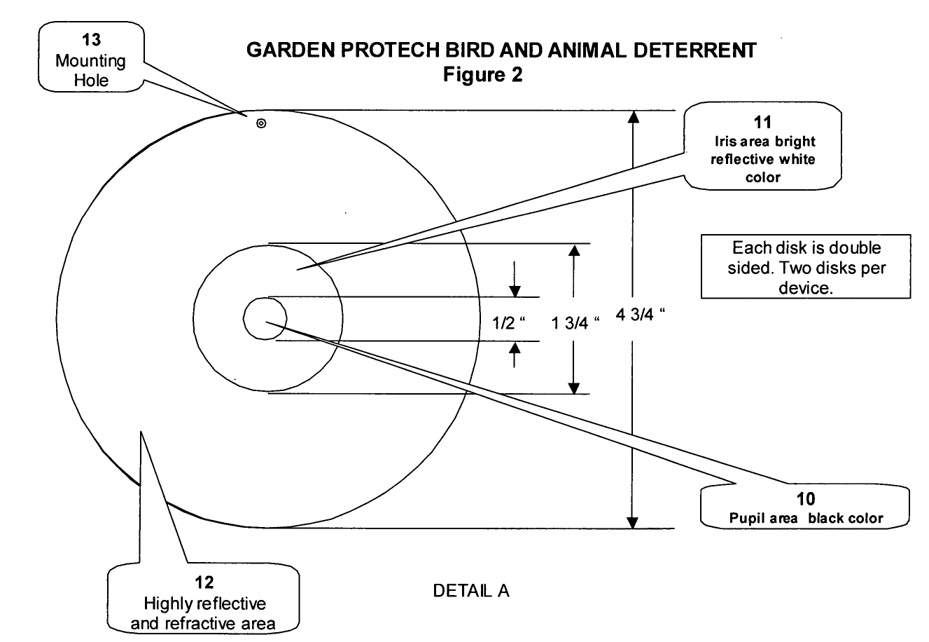

In accordance with another important feature of the present invention, there is shown in FIG. 1 how the apparatus moves about eight degrees of freedom of motion. The first degree of freedom is about the swivel balance point (1). The apparatus is suspended by wire and swivel on a swivel and can rotate clockwise or counterclockwise as viewed standing underneath the suspended apparatus 360 degrees unlimited number of rotations (1) in either direction. The apparatus is symmetrical and non-helical therefore will not exhibit weather vane or propeller type behavior. The second and third degree of freedom is about the axis (4) of each wire suspended refractive reflective disk. The disks (2) are suspended by fixed wire with no swivel such that each disk can independently rotate (pivot) clockwise or counter clockwise as viewed standing underneath either one of the suspended disks. The disks (2) are restricted to approximately + or −60 degrees from the normal position (parallel to the length of the rod) by the torsion resistance of the wire suspension. The fourth degree of freedom is about the balance point (1). The apparatus can seesaw where as one disk (2) goes up, the other disk (2) goes down from the normal balanced position, the length dimension of the rod (3) parallel to the ground plane. The seesaw motion begins and then diminishes with time until the oscillations stop and the normal balanced position is reached. The fifth degree of freedom is the flexing of the rod (3) that creates a slight bouncing up and down motion of the two disks in tandem. The sixth and seventh degree of freedom is the disks (2) rocking or swinging about their axis of the mounting hole (FIGS. 2, 13). The eighth degree of freedom is the entire apparatus can swing back and forth to and fro from its main suspension point (6). All these eight degrees of freedom of motion more or less contribute to the life like animation of the presence of a threat to birds and animals. The degrees of freedom that are critical to the animation are numbers 1, 2, 3, and 4.

Turning to FIG. 2 drawing that is also Detail A there is shown and described in great detail the heart of the design of the apparatus—the two refractive reflective disks. The disks are recycled Computer CD ROM optical disks. They are converted into simulated eyes by using concentric circles of images that appear to the bird or animal as an eye that appears to be focusing on and taking notice of the bird and animal's presence or movements. The center (10) is dark like the pupil of an eye. Another white concentric ring (11) surrounding the center pupil area (10) acts as an iris or even the white part of the eye with either an actual iris image. To accomplish an important function of the invention, the remaining area (12) of the disc from the iris area to the outer diameter utilizes the unique optical characteristics of the disk. The Computer CD ROM disks are like mirrors in one respect as they reflect light but more importantly, the CD ROM disks refract light and break it down into colors and spectrums that emanate from the disk at various angles irrespective of most of the directions of the light source. Since all motion is relative, it does not matter if the disk moves, the light source moves, or the observer moves—it appears that the disk is moving. Birds and animals do not easily discern stationery objects relative to each other because they are colorblind. By way of illustration, one can stand motionless as a bird or animal approaches and one's presence will not be detected unless the animal smells the one or even hears the one's breathing or heartbeat. The slightest motion as breathing or the blinking of the eye is evidence enough for the bird or animal to detect one's presence. This fact has been proven by experimentation by the inventors. As the bird or animal approaches the installed apparatus, it appears to be two eyeballs following the bird or animal's movement and the animal will be deterred from and not enter the area based on a self-perceived and self-motivated reaction to a threat.

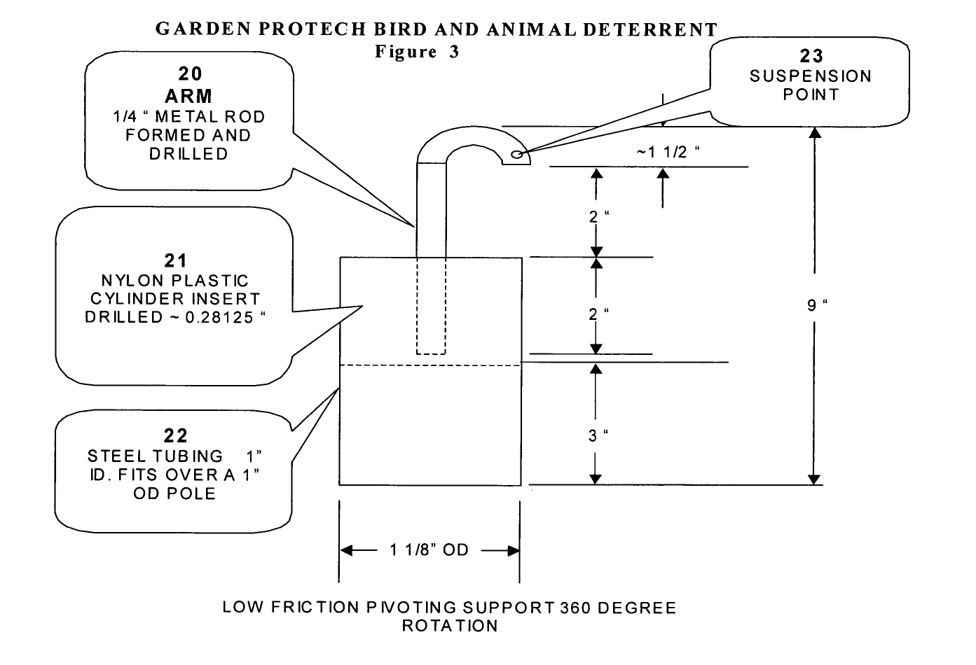

Turning to FIG. 3 drawing there shows an accessory invention that allows the apparatus to be used in areas where the apparatus cannot be suspended, as in a swimming pool area or other open area. The apparatus is suspended by the same main suspension point (FIGS. 1, 6) on the apparatus that would be used to suspend the apparatus otherwise. The accessory device allows for the suspension (23) of the apparatus on a pole and allows for the first and eighth degrees of freedom of motion as described in FIG. 1 above. The operation of the accessory device begins as the rod of the apparatus of FIG. 1 rotates about the suspension axis (23). When the rod rotates, rod makes contact with the side of the accessory arm (20). The momentum of the rod and attached parts and the associated torque produced by the leverage effect overcomes the inertia and friction of the accessory arm (20) causing the accessory arm to rotate in the same direction for an unlimited number of rotations. When the rod and attached rotates in the opposite direction, the rod and attached parts rotates until the rod makes contact with the opposite side of the accessory arm (20) and the same sequence of operation occurs for an unlimited number of rotations in opposite direction.

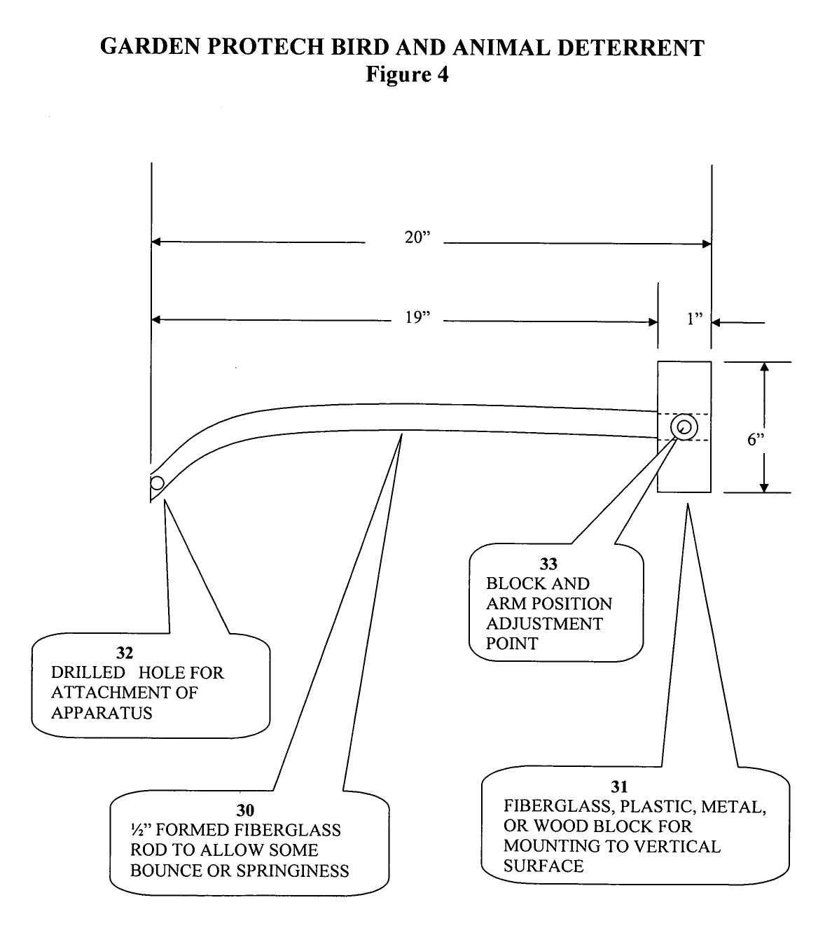

Turning to FIG. 4 drawing there shows an accessory invention that allows the apparatus to be mounted with full capability and range of motion on a more or less vertical surface as a pole or wall. The operation of this accessory device begins as the block (31) is mounted to a vertical surface such as a wall, post, or pole. A feature of the block (31) and arm (30) is the ability for the arm (30) to be adjusted parallel to the ground plane when the block (31) is mounted on a vertical surface that is not perpendicular to the ground plane. The block (31) also has a provision for mounting to a circular or arcing surface (pole) vice a plane or flat surface (wall or post). The block may be anchored by screws to a flat surface and by clamps or screws for round surfaces. Once the arm (30) is leveled, the apparatus is attached to the hole (32) at the end of the arm (30) at the Main Suspension Point (6 of FIG. 1). The arm is composed of fiberglass adding a characteristic bounce or spring to the apparatus. This springiness enhances and augments the life-like operation as previously described.

The advantages of this invention are: Effective for both non-raptorial birds and animals, requires no maintenance once installed, requires no electrical power to operate, requires no chemicals or water, produces no sound, and is perceived by birds and animals to be a live predator, human being, and/or some other threat of presence to non-raptorial and animals including but not limited to squirrels, rabbits, mice, rats, and deer.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An apparatus to repel non-raptorial birds and animals including but not limited to squirrels, rabbits, mice, rats, and deer from selected areas of a property. Said apparatus, when placed in an area, convinces said birds and animals of the presence of a predator, human being, and/or another perceived threatening presence or a danger that causes them to avoid said area and prevents thus a contamination, defacing, and damage to said area from said birds feces or nesting, and consumption and damage of garden plants, agricultural crops, trees, and/or shrubs by said comprising:
two highly reflective and refractive 4¾″ disks with a center image the whole simulating a threat and/or representing a presence of said threat to said birds and said animals by representing two huge eyeballs;
a concentric white ring area 1¾″ diameter that surrounds the center of said disks representing an iris part of an eye or an actual image of a human or a predator animal iris;
a black center area ½″ diameter that presents a pupil of an eye or an actual image of said human or said predator animal pupil;
eight major degrees of freedom (DOF) of movement, two of the eight DOF's are limited to a specific range of rotation to simulate eye movement;
a silent stealth like operation;
requires no electricity, chemicals, water, or batteries;
a specific geometric design, with critical dimensions, and specific materials that have been field proven to be the most effective in achieving the desired deterrent result;
a special low friction pole mount accessory for use in open areas where the device cannot be suspended allowing the device complete freedom of rotation in the plane perpendicular to the pole;
a wall mount accessory that allows the device to be suspended from a surface more or less perpendicular to the ground plane;
a torsion suspension cable that limits the rotation of each said disk to within 60 degrees from either side of the resting position parallel to the length dimension of a support rod; and
very sensitive to an external force including but not limited to thermal air currents and wind which cause the said apparatus to move.

2. The said apparatus of claim 1 wherein any number of single or double sided reflective refractive said disks or other planar reflective and refractive configurations e.g. squares, triangles, trapezoids, and/or rectangles are suspended by wire or supported by pole with any degree of freedom of motion.

3. The said apparatus of claim 1 wherein the source of light is both natural and artificial.

4. The said apparatus of claim 1 wherein referring to the said iris and said pupil areas of said disks, the use of a phosphorescent, a non-phosphorescent, and/or a reflective and/or a refractive material colored other than black and white for effectiveness at night and the use of an image of an iris and a pupil of a human or a predator animal eye incorporated into the embodiment of said apparatus as disclosed herein.

5. The said apparatus of claim 4 wherein referring to all phosphorescent material is a photoluminescence type of material (aka “Glow In The Dark”) material having a minimum 8 hours emission of visible light after the excitation light source is removed or extinguished.

6. The said apparatus of claim 1 wherein said reflective refractive disk that reflects and refracts a natural, artificial, or phosphorescent light in such a way that a reflection of said light is viewable at a wide angle range and produces a circular array of triangular shaped prism refracted reflections that rotate or oscillate about the center of said disk as the plane of said disk pivots about the axis of suspension that is perpendicular more or less to a source of said natural, artificial, or phosphorescent light or by a motion of said birds or said animals relative to a fixed position of said apparatus.

7. The said apparatus of claim 1 further comprising a configuration that utilizes any of the documented dimensions disclosed herein having been determined to be optimum and critical by the inventors to a scientifically proven and tested end use effectiveness of the apparatus.

8. The said apparatus of claim 1 further comprising with respect to said disks, the use of any type of a transparent overlay of images, themes, quotes, mottos, poems, scriptures, pictures, and/or other transparent overlay over any part of said disk surface on either side.

9. The said apparatus of claim 1 further comprising the use of any swivels, quick change connectors, suspension mechanisms, support mechanisms, interlocking rings, gimbals, mounting techniques, and torsion rotation limitation devices in any way and in any position that is similar to the embodiment of said apparatus.

10. The said apparatus of claim 1 wherein any metal part or wire part and metal subpart is composed and manufactured from stainless steel, brass, nickel, monel, bronze, inconel, or any other highly corrosion resistant base metal and not a corrodible metal that is bare, galvanized, electroplated, anodized and/or painted or treated otherwise.

11. The said apparatus of claim 1 wherein the said apparatus must be suspended by the said special low friction pole mount accessory or suspended by the said wall mount accessory to maintain the integrity and effectiveness of said apparatus.
